(19) United States
(12) Patent Application Publication
(10) Pub. No.: US 2007/0127390 A1
(43) Pub. Date: Jun. 7, 2007

(54) Method for providing quality-guaranteed service in converged network and apparatus using the same

(75) Inventor: Sung Hoon Kwak, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/634,496

(22) Filed: Dec. 6, 2006

(30) Foreign Application Priority Data
Dec. 7, 2005 (KR) 10-2005-0119072
Feb. 25, 2006 (KR) 10-2006-0018510

(51) Int. Cl. H04J 1/16

(52) U.S. Cl. 370/252; 370/392

(57) ABSTRACT

A method of providing a quality-guaranteed service on a converged network and a network apparatus using the method are provided. The method includes: receiving a request of a quality-guaranteed service from a user terminal and providing information on the service quality of at least one adjacent network apparatus; receiving service information, including service-quality-information selected by the user terminal in the provided service-quality-information and content information, from the user terminal and transmitting the service information and a traffic-collection-start message to an adjacent network apparatus providing the selected service-quality-information; and transferring a traffic stream received from the adjacent network apparatus, to the user terminal. According to the method and apparatus, a quality-guaranteed service can be provided through a converged network.

### CROSS-REFERENCE TO RELATED PATENT APPLICATIONS

This application claims the benefit of Korean Patent Application No. 10-2005-0119072, filed on Dec. 7, 2005 and Korean Patent Application No. 10-2006-0018510, filed on Feb. 25, 2006, in the Korean Intellectual Property Office, the disclosures of which are incorporated herein in their entirety by reference.

### BACKGROUND OF THE INVENTION

1. Field of the Invention

The present invention relates to a method of providing a service on a converged network and a network apparatus using the method, and more particularly, to a method of providing a quality-guaranteed service and measuring the quality of the provided service and a network apparatus using the method.

2. Description of the Related Art

In the current networks, each of a synchronous optical network/synchronous digital hierarchy (SONET/SDH) network, an Ethernet network, a frame relay network, and a mobile communication network is independently constructed and operated according to the type and characteristics of services provided through the networks. Heterogeneous networks are connected through a predetermined connection apparatus and only services in already set forms can be provided. However, as the development of technologies related to a converged network has been rapidly evolving, the boundaries between the networks have been gradually disappearing. This change reflects demands of users who want to receive a more variety of services through a single interface. A network apparatus such as a multi-service provisioning platform, has a variety of line interfaces, such as PDH, SONET/SDH, and Ethernet, in a single system, and with being connected to different networks at the same time, provides all of a packet-type service, a circuit-type service, and a packet and circuit hybrid service. For example, a SONET/SDH network was designed with a main purpose of providing a voice telephone service, but with the introduction of a packet over SONET/SDH (POS) or Ethernet over SONET/SDH (EoS) technology, the quantity of IP datagram or Ethernet frames is increasing even in the SONET/SDH network. In case of voice over IP (VoIP) that is a telephone service over the Internet, commercial services of the VoIP have been already provided. Thus, due to the introduction of new network apparatuses and increasing network convergence, users have been able to receive a variety of services, such as voice telephone, the Internet, and video on demand services, in a single interface connected to a network.

However, one of issues that should be addressed in the converged network environment as described above is guaranteeing the quality of a service. For example, multimedia services are currently provided through the Internet in either of a streaming service method and a downloading method. The multimedia service by the downloading method includes a video server storing multimedia content files and a user client. The multimedia content server loads a requested multimedia content file on TCP packets and transmits the packets to a user client requesting the service. The user client receives the TCP packets and then, plays the received file back. However, in this method, a time for the user to wait to confirm the contents is very long and the time varies with respect to the situation of a network. Also, this method has a drawback that a storage space to store the entire multimedia contents is required in the user terminal.

The multimedia service using the streaming method uses a real-time transfer protocol/user datagram protocol (RTP/UDP). By using a time stamp field, synchronization between media is performed to generate RTP packets, and then the RTP packets are loaded on the UDP and transmitted. At this time, in the RTP/UDP-based streamlining service, received multimedia information is buffered only in a short initial time and reproduced. Accordingly, it does not require a large storage space in a user terminal, but due to lost packets or transmission jitters, interruption frequently occurs when multimedia contents are reproduced.

### SUMMARY OF THE INVENTION

The present invention provides a method of providing a quality-guaranteed service through a converged network and measuring the quality of the provided service, and a network apparatus using the method.

According to an aspect of the present invention, there is provided a method of providing a quality-guaranteed service by a network apparatus directly connected to a user terminal on a converged network, the method including: receiving a request of a quality-guaranteed service from the user terminal and providing information on the service quality of at least one adjacent network apparatus; receiving service information, including service-quality-information selected by the user terminal in the provided service-quality-information and content information, from the user terminal, and transmitting the service information and a traffic-collection-start message to an adjacent network apparatus providing the selected service-quality-information; and transferring a traffic stream received from the adjacent network apparatus, to the user terminal.

According to another aspect of the present invention, there is provided a method of providing a quality-guaranteed service by a first network apparatus directly connected to a user terminal and an adjacent network apparatus on a converged network, the method including: if service information, including content information and the service-quality-information selected by the user terminal, and a message requesting to begin collecting traffic are received from the first network apparatus, determining a traffic-collection-threshold and collecting traffic; and if the accumulate quantity of the collected traffic is greater than the traffic-collection-threshold, streaming the collected traffic.

According to another aspect of the present invention, there is provided an apparatus for providing a quality-guaranteed service by a network apparatus directly connected to a user terminal on a converged network, the apparatus including: a quality information providing unit receiving a request of a quality-guaranteed service from the user terminal and providing information on the service quality of at least one adjacent network apparatus; a message transmission unit receiving service information, including service-quality-information selected by the user terminal in the provided service-quality-information and content information, from the user terminal, and transmitting the service information and a traffic-collection-start message to an adjacent network apparatus providing the selected service-quality-information; and a stream transferring unit transferring a traffic stream received from the adjacent network apparatus, to the user terminal.

According to another aspect of the present invention, there is provided an apparatus for providing a quality-guaranteed service by a network apparatus adjacent to a first network apparatus directly connected to a user terminal on a converged network, the apparatus including: a traffic collection unit, if service information, including content information and information on a service quality selected by the user terminal, and a message requesting to begin collecting traffic are received from the first network apparatus, determining a traffic-collection-threshold and collecting traffic; and a traffic streaming unit, if the accumulate quantity of the collected traffic is greater than the traffic-collection-threshold, streaming the collected traffic.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a system for providing a quality-guaranteed service in a converged network according to an embodiment of the present invention;

FIG. 2 is a block diagram illustrating a detailed structure of a first network apparatus of FIG. 1 according to an embodiment of the present invention;

FIG. 3 is a block diagram illustrating a detailed structure of second network apparatuses of FIG. 2 according to an embodiment of the present invention; and

FIGS. 4 and 5 are flowcharts illustrating a method of providing a quality-guaranteed service on a converged network according to an embodiment of the present invention.

### DETAILED DESCRIPTION OF THE INVENTION

The present invention will now be described more fully with reference to the accompanying drawings, in which exemplary embodiments of the invention are shown.

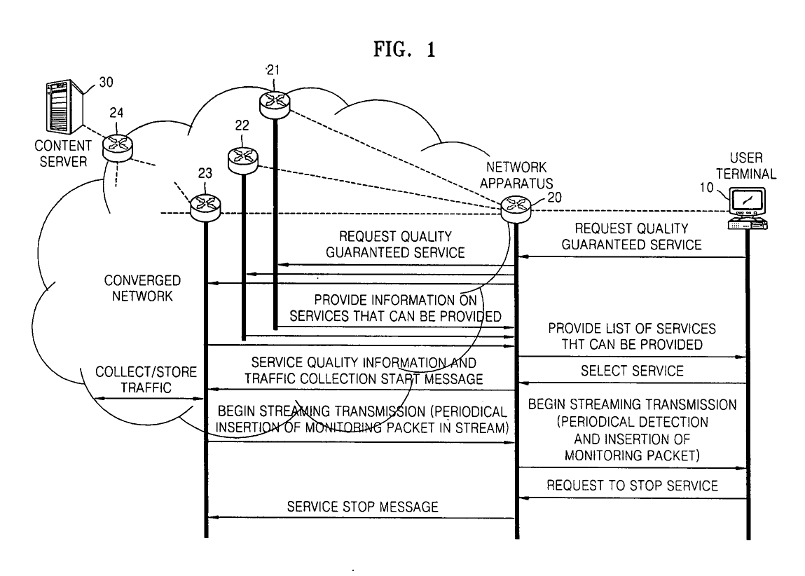

FIG. 1 illustrates a system for providing a quality-guaranteed service in a converged network according to an embodiment of the present invention.

Referring to FIG. 1, the system according to an embodiment of the present invention is composed of a user terminal 10, a first network apparatus 20, second network apparatuses 21, 22 and 23, another network apparatus 24, and a content server 30.

Here, the converged network is a network in which a variety of networks, such as a SONET/SDH network, an Ethernet network, a frame relay network, and a mobile communication network, are connected with each other. Also, the user terminal 10 is an apparatus which a user uses. Examples of the network apparatuses 20 through 24 may include a router, an exchange, a switch, a multi-service provision platform (MSPP), and a media gateway. The content server 30 is connected to the network, stores contents, and provides desired contents to a user.

Meanwhile, among the network apparatuses 20 through 24, the first network apparatus 20 means a network apparatus directly connected to a user or user terminal 10 requesting a quality-guaranteed service. Here, the direct connection means that two apparatuses have a physical layer connection. The second network apparatuses 21, 22 and 23 are network apparatuses adjacent to the first network apparatus 20. That is, the second network apparatuses 21, 22 and 23 are directly connected with the first network apparatus 20 and connected to the user terminal 10 through the first network apparatus 20.

The first network apparatus 20 which is an apparatus forming the converged network receives a quality-guaranteed service request from the user terminal 10 and requests the second network apparatuses 21, 22 and 23 to transmit information on quality-guaranteed services that can be provided. After collecting a list of services that can be provided from the second network apparatuses 21, 22 and 23, the first network apparatus 20 reports the list of services that can be provided to the user terminal 10, and the user selects a desired service in the reported service list. After receiving information on the service selected by the user from the user terminal 10, the first network apparatus 21 transmits negotiated service-quality-information and a message requesting the second network apparatus 23 providing the selected service, to begin to collect and store traffic, to the second network apparatus 23. The second network apparatus 23 receiving the message begins collecting traffic, and determines a threshold for storing traffic based on a traffic collecting speed, a traffic collecting method, and the negotiated service-quality-information. If the stored quantity of collected traffic begins to exceed the traffic storage threshold, the second network apparatus 23 performing a method of the present invention begins traffic streaming transmission. Also, the second network apparatus 23 inserts a monitoring packet to the transmission stream periodically. The first network apparatus 20 monitors the communication quality between the network apparatuses 20 and 23, by detecting the monitoring packet included in the traffic stream received from the second network apparatus 23, and periodically inserts a monitoring packet to a traffic stream transmitted to the user terminal 10.

The embodiment of the present invention will now be explained in more detail with reference to specific examples. The user terminal 10 is connected to the first network apparatus 20 through a 100 Mbps Ethernet interface. The first network apparatus 20 is connected with the second network apparatuses 21, 22 and 23 through a gigabit Ethernet (GbE) interface. At this time, the network apparatus 20 which receives a quality-guaranteed service request from the user terminal 10 requests the second network apparatuses 21, 22 and 23 to transmit information on quality-guaranteed services that can be provided. Among the second network apparatuses 21, 22 and 23 which receive a request for quality-guaranteed service information, the second network apparatus 21 transmits a reply indicating that two services having service qualities of 100 Mbs/99% and 50 Mbps/99%, respectively, are available; the second network apparatus 22 transmits a reply indicating that a service having a service quality of 10 Mbs/90% is available; and the second network apparatus 23 transmits a reply indicating that two services having service qualities of 100 Mbs/90% and 10 Mbps/90%, respectively, are available, The first network apparatus 20 which receives the replies provides the service list to the user terminal 10. The user selects the 10 Mbps/99% service in the provided service list. The first network apparatus 20 which receives the information on the service selected by the user transmits the user-selected service information (10 Mbps/99%), requested content information, and a message requesting the second network apparatus 23 to begin collecting information, to the second network apparatus 23. After receiving the user-selected service information (10 Mbps/99%), the requested content information, and the message requesting to begin collecting information from the first network apparatus 20, the second network apparatus 23 begins collecting the content traffic, and calculates a traffic-collection-threshold based on the service-quality-information, a traffic collecting method, and a traffic collection rate. Here, examples of the method of collecting traffic may include a best-effort method, a bandwidth reservation method, and a method using a synchronization frame such as an EoS, but the method is not limited to these. If the accumulated quantity of the collected traffic begins to exceed the traffic-collection-threshold, the second network apparatus 23 begins streaming transmission of the traffic to the first network apparatus 20. Also, during the streaming transmission, a monitoring packet is periodically inserted. The first network apparatus 20 monitors the received streaming quality by detecting the monitoring packet periodically included in the traffic stream received from the second network apparatus 23, and links the traffic stream to the user terminal 10. By inserting monitoring packets to the linked traffic stream, the first network apparatus can monitor the streaming transmission quality. In the user terminal 10, by detecting the periodical monitoring packets included in the received stream, the quality of the requested service can be measured. When the user wants to stop the quality-guaranteed service, by sending a stop message to the first network apparatus 20, the service can be terminated.

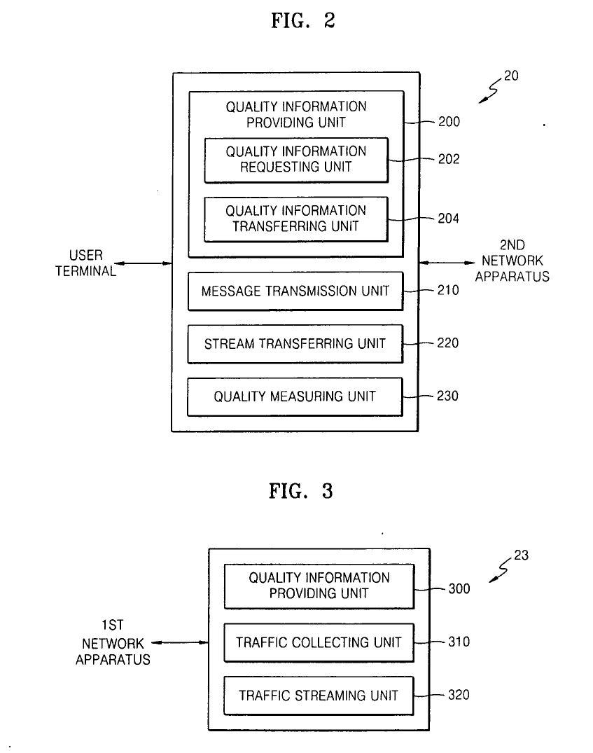

FIG. 2 is a block diagram illustrating a detailed structure of the first network apparatus 20 of FIG. 1 according to an embodiment of the present invention. The first network apparatus 20 is composed of a quality information providing unit 200, a message transmission unit 210, a stream transferring unit 220 and a quality measuring unit 230.

The quality information providing unit 200 receives a request of a quality-guaranteed service from the user terminal 10, and provides information on the service qualities of the second network apparatuses 21, 22 and 23 to the user terminal 10. Referring to FIG. 2, the quality information providing unit 200 is composed of a quality information requesting unit 202 and a quality information transferring unit 204.

The quality information requesting unit 202 receives a request for a quality-guaranteed service from the user terminal 10 and requests the second network apparatuses 21, 22 and 23 to transmit information on service qualities that can be provided. The quality information transferring unit 204 transfers the service-quality-information received from the second network apparatuses 21, 22 and 23, respectively, to the user terminal 10. Here, examples of service-quality-information may include a transmission rate, a packet loss ratio, a transmission delay, and a delay deviation, but the information is not limited to these.

The message transmission unit 210 receives service information including content information and information on the service selected by the user terminal 10 in the provided service-quality-information, and transmits the service information and a message to requesting the second network apparatus 23 to begin collection of traffic, to the second network apparatus 23.

The stream transferring unit 220 transfers the traffic stream received from the second network apparatus 23 to the user terminal 10.

The quality measuring unit 230 measures the quality of the service based on the monitoring packets inserted in the received traffic stream. Here, an example of a unit inserting a monitoring packet is the second network apparatus 23.

Meanwhile, the stream transferring unit 220 may have a function for inserting a monitoring packet to the received traffic stream and transferring the stream to the user terminal 10. In this case, the user terminal 10 can measures the quality of the service between the user terminal 10 and the first network apparatus 20 based on the inserted monitoring packet.

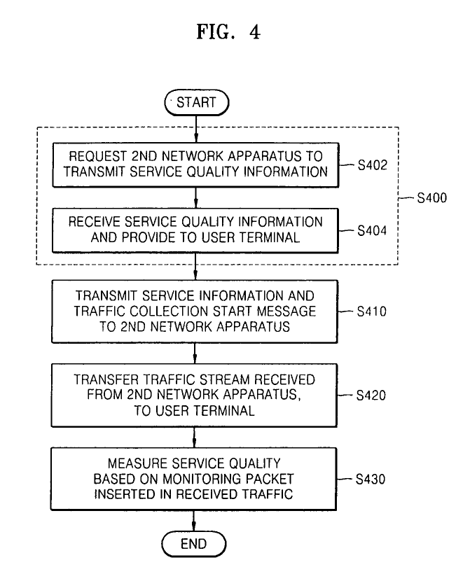

FIG. 3 is a block diagram illustrating a detailed structure of the second network apparatuses 21, 22 and 23 of FIG. 2 according to an embodiment of the present invention. Each network apparatus is composed of a quality information providing unit 300, a traffic collecting unit 310 and a traffic streaming unit 320.

In response to a request from the first network apparatus 20, the quality information providing unit 300 provides information on the service quality that can be provided, to the first network apparatus 20.

If the traffic collecting unit 310 receives service information, including information on the service quality selected by the user terminal 10 and content information, and a message requesting to begin collecting traffic, from the first network apparatus 20, the traffic collecting unit 310 determines a traffic-collection-threshold and collects traffic. Here, an example of the method of determining the traffic-collection-threshold may include determining the threshold based on a traffic collecting speed, a traffic collecting method, and the selected service-quality-information, but the method is not limited to this.

If the accumulated quantity of the collected traffic is greater than the traffic-collection-threshold, the traffic streaming unit 320 streams the collected traffic. Meanwhile, by inserting a monitoring packet into the collected traffic, the traffic streaming unit 320 can allow the first network apparatus 20 to measure the service quality by using the monitoring packet.

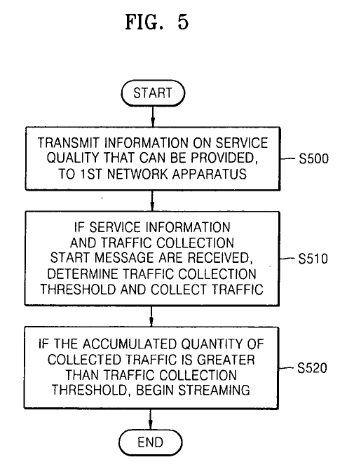

FIG. 4 is a flowchart illustrating a method of providing a quality-guaranteed service on a converged network according to an embodiment of the present invention, and illustrates an operation of the first network apparatus 20 of FIG. 1.

Referring to FIGS. 1 and 4, first, a request for a quality-guaranteed service from the user terminal 10 is received, and information on services qualities of the second network apparatuses 21, 22 and 23 is provided to the user terminal 10 in operation S400. The operation S400 may include receiving the request for the quality-guaranteed service from the user terminal 10 and requesting the second network apparatuses 21, 22 and 23 to transmit information on service qualities that can be provided in operation S402, and providing service-quality-information received from the second network apparatuses 21, 22 and 23, respectively, to the user terminal 10 in operation S404. Here, examples of service-quality-information may include a transmission rate, a packet loss ratio, a transmission delay, and a delay deviation, but the information is not limited to these.

Next, service information, including content information and information on the service quality selected by the user terminal 10 in the provided service-quality-information, is received from the user terminal 10, and the service information and a message, requesting the second network apparatus 23 providing the selected service-quality-information, to begin collecting traffic, are transmitted to the second network apparatus 23 in operation S410.

After operation 410, the traffic stream received from the second network apparatus 23 is transferred to the user terminal 10 in operation S420. Meanwhile, an operation for inserting a monitoring packet to the traffic stream received and transferring the stream to the user terminal 10 may be further included in operation S420. The thus inserted monitoring packet is used by the user terminal 10 in measuring the quality of the service.

The quality of the service is measured based on the monitoring packet inserted into the received traffic stream in operation S420 in operation S430.

FIG. 5 is a flowchart illustrating a method of providing a quality-guaranteed service on a converged network according to an embodiment of the present invention, and illustrates an operation of the second network apparatus 23 of FIG. 1.

Referring to FIGS. 1 and 5, first, in response to the request from the first network apparatus 20, information on the service quality that can be provided is provided to the first network apparatus 20 in operation S500.

If the service information, including content information and information on the service quality selected by the user terminal 10, and the message, requesting the second network apparatus 23 to begin collecting traffic are received from the first network apparatus 20, a traffic-collection-threshold is determined and traffic is collected in operation S510. Here, an example of the method of determining the traffic-collection-threshold may include determining the threshold based on a traffic collecting speed, a traffic collecting method, and the selected service-quality-information, but the method is not limited to this.

If the accumulated quantity of the collected traffic is greater than the traffic-collection-threshold, the collected traffic is streamed in operation S520. An operation for inserting a monitoring packet to the collected traffic may be further included in operation S520, and the thus inserted monitoring packet is used by the first network apparatus 20 in measuring the quality of the service.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

According to the present invention, a quality-guaranteed service through a converged network can be provided and end-to-end transmission jitters can be compensated for such that the quality of a real-time multimedia streaming service can be enhanced. Also, by using the monitoring packet, the service quality of the network side and the service quality of the user side are measured at the same time such that when the service quality is degraded, it can be determined whether the network apparatus or the user terminal causes the degradation.

What is claimed is:

1. A method of providing a quality-guaranteed service by a network apparatus directly connected to a user terminal on a converged network, the method comprising:
receiving a request of a quality-guaranteed service from the user terminal and providing information on the service quality of at least one adjacent network apparatus;
receiving service information, including service-quality-information selected by the user terminal in the provided service-quality-information and content information, from the user terminal, and transmitting the service information and a traffic-collection-start message to an adjacent network apparatus providing the selected service-quality-information; and
transferring a traffic stream received from the adjacent network apparatus, to the user terminal.

2. The method of claim 1, wherein the providing of the information on the service quality to the user terminal comprises:
receiving the quality-guaranteed service from the user terminal and requesting information on services qualities provided by the adjacent network apparatuses; and
providing information on service qualities received from the adjacent network apparatuses, respectively, to the user terminal.

3. The method of claim 1, further comprising measuring the quality of the service based on a monitoring packet inserted in the received traffic stream.

4. The method of claim 1, wherein the transferring of the traffic stream to the user terminal comprises
inserting a monitoring packet into the received traffic stream and transferring the traffic stream to the user terminal.

5. The method of claim 1, wherein the service-quality-information comprises at least one of a transmission rate, a packet loss ratio, a transmission delay, and a delay deviation.

6. A method of providing a quality-guaranteed service by a first network apparatus directly connected to a user terminal and an adjacent network apparatus on a converged network, the method comprising:
if service information, including content information and information on a service quality selected by the user terminal, and a message requesting to begin collecting traffic are received from the first network apparatus, determining a traffic-collection-threshold and collecting traffic; and
if the accumulate quantity of the collected traffic is greater than the traffic-collection-threshold, streaming the collected traffic.

7. The method of claim 6, further comprising providing information on service qualities that can be provided, in response to the request of the first network apparatus, to the first network apparatus.

8. The method of claim 6, wherein the streaming of the collected traffic comprises inserting a monitoring packet into the collected traffic.

9. The method of claim 6, wherein the determining of the traffic-collection-threshold comprises determining the traffic-collection-threshold based on a traffic collecting speed, a traffic collecting method, and the information on the selected service quality.

10. An apparatus for providing a quality-guaranteed service by a network apparatus directly connected to a user terminal on a converged network, the apparatus comprising:
a quality information providing unit receiving a request of a quality-guaranteed service from the user terminal and providing information on the service quality of at least one adjacent network apparatus;
a message transmission unit receiving service information, including service-quality-information selected by the user terminal in the provided service-quality-information and content information, from the user terminal, and transmitting the service information and a traffic-collection-start message to an adjacent network apparatus providing the selected service-quality-information; and
a stream transferring unit transferring a traffic stream received from the adjacent network apparatus, to the user terminal.

11. The apparatus of claim 10, wherein the quality information providing unit comprises:
a quality information requesting unit receiving the quality-guaranteed service from the user terminal and requesting information on services qualities provided by the adjacent network apparatuses; and
a quality information transferring unit providing information on service qualities received from the adjacent network apparatuses, respectively, to the user terminal.

12. The apparatus of claim 10, further comprising a quality measuring unit measuring the quality of the service based on a monitoring packet inserted in the received traffic stream.

13. The apparatus of claim 10, wherein the stream transferring unit inserts a monitoring packet into the received traffic stream and transfers the traffic stream to the user terminal.

14. The apparatus of claim 10, wherein the service-quality-information comprises at least one of a transmission rate, a packet loss ratio, a transmission delay, and a delay deviation.

15. An apparatus for providing a quality-guaranteed service by a network apparatus adjacent to a first network apparatus directly connected to a user terminal on a converged network, the apparatus comprising:
a traffic collection unit, if service information, including content information and information on a service quality selected by the user terminal, and a message requesting to begin collecting traffic are received from the first network apparatus, determining a traffic-collection-threshold and collecting traffic; and
a traffic streaming unit, if the accumulate quantity of the collected traffic is greater than the traffic-collection-threshold, streaming the collected traffic.

16. The apparatus of claim 15, further comprising a quality information providing unit providing information on service qualities that can be provided, in response to the request of the first network apparatus, to the first network apparatus.

17. The apparatus of claim 15, wherein the traffic streaming unit inserts a monitoring packet into the collected traffic.

18. The apparatus of claim 15, wherein the traffic collection unit determines the traffic-collection-threshold based on a traffic collecting speed, a traffic collecting method, and the information on the selected service quality.

19. A computer readable recording medium having embodied thereon a computer program for executing method of claim 1.
